(19) United States
(12) Patent Application Publication
(10) Pub. No.: US 2009/0263780 A1
(43) Pub. Date: Oct. 22, 2009

(54) Organ preservation fluid

(76) Inventor: Yanming Wang, Malden, MA (US)

Correspondence Address: YANMING WANG, 203 SUMMER STREET, MALDEN, MA, 02148, US

(21) Appl. No.: 12/148,111

(22) Filed: Apr. 17, 2008

(51) Int. Cl. A01N 1/02

(52) U.S. Cl. 435/1.2; 435/284.1

(57) ABSTRACT

Novel organ preservation fluids, as well as related articles and methods, are disclosed.

### BACKGROUND

Preservation of organs awaiting transplantation has become common practice in many hospitals. After leaving a donor body, a donor organ can suffer from ischemia injury, mostly due to deprivation of blood flow, which results in inadequate nutrient & oxygen in the donor organ. When the blood flow in the donor organ is restored after it is being placed in a recipient body, the donor organ can also suffer from reperfusion injury. Ischemia/reperfusion injury is characterized by severe edema. Although a donor organ is typically cooled to about 4° C. and placed in a plastic bag submerged in a buffered salt solution after it is harvested, one of the biggest challenges is the limited length of time that a donor organ will remain viable before the transplant surgery is carried out. Preservation of the viability of donor organs is therefore an important goal for organ transplantation.

The basic living unit of the body is cells, and each organ is an aggregate of many different cells held together by intercellular supporting structures. The cells depend on nourishing environment to live. Interstitial fluid (ISF) provides the essential nutrients needed by the cells for maintenance of cellular life.

Many organ preservation fluids have been used empirically, including, normal saline and University of Wisconsin (UW) solution, St Thomas' solution, Euro-Collins solution, Celsior solution, Histidinetryptophan-α-Ketoglutarate solution (HTK), Stanford solution, and Papworth solution. However, the efficacy of these organ preservation fluids is unclear, and donor organ damage has been reportedly induced by some of organ preservation fluids. For example, it has been reported that incubating a donor organ in Euro-Collins and St Thomas solutions for a prolonged period of time caused significant endothelial cell losses and diffuse morphological damages. The ingredients of the currently available organ preservation fluids generally include sodium, potassium, calcium, magnesium, chloride, bicarbonate, phosphate, sulfate, glucose, raffinose, lactobionic acid, allopurinol, glutathione, adenosine, pentafraction, histidine, mannitol, insulin, glutamic acid, penicillin G, dexamethasone. However, none of the organ preservation fluids contains a polypeptide that can easily enter ISF.

As a defense strategy, energy production of a donor organ switches from oxidative metabolism to anaerobic glycolysis after being harvested. Although glycolytic pathway does not provide energy as efficient as oxidative phosphorylation, it becomes crucial for the maintenance of donor organ's viability after harvest.

To preserve donor organ, it is important to optimize ISF nutrients to improve the cell tolerance to ischemia.

### SUMMARY

The inventor has found that the protein concentration in ISF mainly determines the tolerance to ischemia/reperfusion injury, and that the higher the protein concentration in the ISF, the more cellular tolerance to injuries. The inventor has also found that the limited passage of albumin (having a molecular weight of about 68 KDa and a pI of about 4.8), and of protein generally, from the blood system into the ISF through capillary wall, is primarily due to its large molecular weight and low isoelectric point (PI).

Further, the inventor has found that a higher polypeptide concentration in the ISF can prevent or minimize ischemia/reperfusion injury to a donor organ after the donor organ leaves the donor body. The inventor has also found high concentrations of Mg²⁺, ATP and insulin are conducive to the preservation of a donor organ and improve the viability of a donor organ after it is harvested.

Accordingly, in one aspect, this disclosure features articles that include a composition (e.g., an organ preservation fluid) and a transplant, at least a portion of which is in the composition. The composition includes about 0-155 meq/L (e.g., about 20-150 meq/L) of Na, about 0.1-5 meq/L (e.g., about 2-3 meq/L) of K, about 0.1-3 meq/L (e.g., about 1-2 meq/L) of Ca, about 0-150 meq/L (e.g., about 1-20 meq/L) of P, about 0-200 meq/L (e.g., about 20-150 meq/L) of Cl, about 1-200 meq/L (e.g., about 2-60 meq/L) of Mg, about 0-30 meq/L (e.g., about 10-20 meq/L) of HCO₃, about 0-150 meq/L (e.g., about 0-30 meq/L) of SO₄, about 0-200 mg/dl (e.g., about 20-120 mg/dl) of glucose, about 0-50 mM (e.g., about 5-50 mM) of a glycolysis stimulating reagent, water, about 0-200 mM (e.g., about 0.02-2 mM) of ATP, about 0-100 μU/ml (e.g., about 0-1 μU/ml) of insulin, and an effective amount of a polypeptide having a molecular weight of less than about 60 kDa (e.g., less than about 45 kDa or less than about 30 kDa) or a polypeptide having an pI of more than about 4.8 (e.g., more than about 6 or more than about 7).

As used herein, the term “polypeptide” refers a polymer containing at least two amino acids that are linked by a peptide bond. The polypeptide can be obtained from animal sources. For examples, gelatin polypeptides can be derived from collagen digested by an acid, a base, or an enzyme (such as trypsin, pepsin, or collagenase). The polypeptide can also be either a chemically synthesized polypeptide or a recombinantly produced polypeptide. Preferably, the polypeptide has a molecular weight between about 500 Da to about 30 kDa and has an pI between about 6 to about 8. The polypeptide typically does not require any known specific biological function and does not easily enter cell body. Examples of suitable polypeptide include albumin derivatives (e.g., fragments of albumins such as human or animal albumin), gelatins and their derivatives, and sericins and their derivatives.

Reagents that can stimulate glycolysis are conducive to donor organ viability, and therefore, can be added into an organ preservation composition described above. Such glycolysis stimulating reagents include, glycolysis intermediates (such as fructose-1,6-biphophate, glyceraldehyde-3-phosphate, 1,3 bisphosphoglycerate, 3-phosphoglycerate, 2-phosphoglycerateare, phosphoenolpyruvate, pyruvate, or lactate), and enzymes for glycolysis (such as hexokinase, phosphoglucose isomerase, phosphofructokinase, aldolase, triosephosphate isomerase, glyceraldehydes 3-phosphate dehydrogenase, phosphoglycerate kinase, or pyruvate kinase). For example, about 0.01-50 mM of fructose-1,6-diphosphate can be added in addition to glucose or to replace glucose in the organ preservation composition.

The organ preservation composition can have an osmolality between about 270-400 mOsm/L and a pH between about 6.8-7.5. The transplant can be any organ transplant of the body, such as heart transplant, a kidney transplant, a liver transplant, a lung transplant, a brain transplant, a spinal cord transplant, or an intestine transplant, skin transplant. The articles can be articles containing an organ preservation fluid (e.g., in a jar) and an organ transplant, at least a portion of which is in the organ preservation fluid (e.g., completely immersed in the organ preservation fluid).

In another aspect, this disclosure features methods that include immersing at least a portion of a transplant in one of the organ preservation compositions described above. The methods can also include perfusing at least a portion of the transplant with the composition prior to immersing the transplant in the composition. After the transplant is immersed in the composition, it can be stored at 4° C. for future use.

### DETAILED DESCRIPTION

Donor organs need optimized nutrients in ISF to survive ischemia condition. High concentration of Mg, ATP, insulin and polypeptides are conducive to fighting against ischemia. For example, one of the most important nutrients is plasma protein (mainly albumin). Albumin binds water and electrolytes, and slow down entry of water and electrolytes (mainly Na⁺) into cell body, hence protecting the cells from swelling.

Although the ISF derives from the blood, the concentration of protein in the ISF (e.g., typically about 2 to 3 g/dl) is always lower than that in the blood (i.e., about 7.3 g/dl) in plasma. This is because capillaries are only partially permeable to plasma protein. The ISF in central nervous system (CNS) contains the lowest concentration of protein (about 25 mg/dl), because of the blood brain barrier (BBB) and blood-cerebrospinal fluid barriers. As a result, cells in the peripheral organ system are much more tolerant than cells in the CNS.

In the capillaries of peripheral organ systems, adjacent endothelial cells form an intercellular cleft, which normally has a uniform spacing with a width of about 6 to 7 nanometers. However, albumin is a large molecule with a molecular weight of about 68,000 Daltons and a diameter size slightly larger than 7 nanometers. As a result, it is difficult for albumin to pass through capillaries to enter into ISF. In addition, the endothelium and surrounding basement membrane are negatively charged, due to the presence of exposed acidic residues. Proteins are amphoteric molecules carrying positive, negative, or neutral charges depending on the local pH environment. The net charge of a protein is the sum of all the negative and positive charges of its amino acid side chains, and its amino- and carboxyl-termini. The isoelectric point (pI) is the pH at which the net charge of the protein is zero. At a pH below its pI, a protein carries a net positive charge, while at a pH above its pI, a protein carries a net negative charge. Native albumin typically has a pI of about 4-4.8, and is therefore negatively charged in human blood, which has a physiological pH of about 7.35-7.45. As a result, there is a rejective action between endothelium and albumin. Thus, given the high molecular weight and low pI of the native albumin, the ISF contains only about 2-3 gram/dl of albumin in peripheral organ systems, much lower than the amount of albumin in the blood (i.e., about 7.3 g/dl).

In clinic, intravenous albumin injection has been used for treating various injuries. However, due to its large molecular weight and low pI, albumin does not easily enter the ISF to reduce or prevent ischemia injuries.

The inventor has found that the passage of a polypeptide across a capillary into the ISF is determined primarily by two factors described above, i.e. the molecular weight and the pI. Polypeptides with a smaller molecular weight (e.g., less than about 60 kDa) pass through capillary walls more easily. Further, polypeptides with a higher pI (e.g., higher than about 4.8) carry fewer negative charges, which reduces rejective action between the endothelium and the polypeptides, and therefore are easier to enter into ISF. Polypeptides with both a lower molecular weight and a higher pI exhibit a synergistic effect in ease of entering into the ISF.

Thus, in one aspect, this disclosure features organ preservation compositions that include one or more polypeptides having a molecular weight less than about 60 kDa or having a pI of more than about 4.8. The specific amino acid sequence and structure of the polypeptides are not critical, so long as the molecular weight and/or pI are in the effective range. Only non-toxic polypeptides can be used in the compositions described above. Preferably, the polypeptide has no specific biological function. However, polypeptides with a specific biological function can also be used if they are denatured or do not cause serious complication.

The preferred amino acid and percentage range of polypeptides useful in the compositions described above are listed in the following Tables I and II:

TABLE I
Amino acid composition

| Amino acid | content (%) |
|---|---|
| Alanine | 0-20 |
| Arginine | 0-20 |
| Aspartic acid | 0-20 |
| Cystine | 0-30 |
| Cysteine | 0-30 |
| Glutamic acid | 0-30 |
| Glycine | 0-30 |
| Histine | 0-30 |
| Hydroxylysine | 0-30 |
| Hydroxyproline | 0-30 |
| Isoleucine | 0-30 |
| Leucine | 0-30 |
| Lysine | 0-20 |
| Methionine | 0-20 |
| Phenylalanine | 0-20 |
| Proline | 0-30 |
| Serine | 0-20 |
| Threonine | 0-20 |
| Tryptophan | 0-20 |
| Tyrosine | 0-20 |
| Valine | 0-20 |

TABLE II
Preferred amino acid range

| Amino acid | content (%) |
|---|---|
| Alanine | 4-10 |
| Arginine | 6-20 |
| Aspartic acid | 5-11 |
| Cystine | 0.1-6 |
| Cysteine | 0.1-0.7 |
| Glutamic acid | 10-17 |
| Glycine | 1.6-30 |
| Histine | 0.6-20 |
| Hydroxylysine | 0.6-1.8 |
| Hydroxyproline | 10-14 |
| Isoleucine | 1.5-2 |
| Leucine | 2-14 |
| Lysine | 3-25 |
| Methionine | 0.5-2 |
| Phenylalanine | 2-8 |
| Proline | 2-18 |
| Serine | 2-5 |
| Threonine | 1-4 |
| Tryptophan | 0-0.2 |
| Tyrosine | 0.4-6 |
| Valine | 2-3 |

The polypeptides can be isolated from animal sources and then purified before use. One example of a suitable protein is gelatin. Gelatins can be derived from animal skin, bone or other organs. Gelatins with various molecular weight ranges are commercially available. Albumin derivates (e.g., fragments of albumins) can also be used. Sericin, consisting of proteins derived from silkworm cocoon, can also be used in the composition described above and is commercially available.

Enzyme digestion, such as trypsin digestion or hydrolysis by acid or base, can be used to produce polypeptides with wide ranges of molecular weights (e.g., relatively low molecular weights).

As used herein, a polypeptide is a “derivative” of another if it is a modification of a polypeptide, e.g., the product of processing a polypeptide with an enzyme, the hydrolytes of a particular polypeptide, or a fragment of a particular polypeptide, or a product obtained by modifying the pI of a particular polypeptide. For example, an albumin derivative can be a compound obtained by increasing albumin's pI by treating the albumin with carbodiimide and ethylene diamine. Detailed methods for changing the pI of a polypeptide are known in the art and have been described in, for example, Griffin D E, et al., “Study of protein characteristics that influence entry into the cerebrospinal fluid of normal mice and mice with encephalitis” J. Clin. Invest. 1982. 70:289-295 and Hoare et al., “A method for the quantitative modification and estimation of carboxylic acid groups in proteins” J. Biol. Chem. 1967 242:2447-2453, the contents of which are incorporated herein by reference in their entirety.

The polypeptides can also be chemically synthesized or produced recombinantly, methods for which are well-known to those of skill in the art.

When polypeptides are chemically synthesized, more amino acids having higher pI can be used to yield polypeptides with a higher pI. Alternatively, a hydrolytic process with an acid can also increase pI. For example, acid-cured gelatin (type A) typically has a pI between 7.0-9.0, while lime-cured gelatin (type B) has a pI usually between 4.7-5.2.

Of importance in designing a polypeptide for use in the compositions described above is its water and electrolytes binding capacity. Polypeptides with a higher molecular weight have more capacity to bind water and electrolytes than those with a smaller molecular weight. However, with a larger number of molecules, polypeptides with a smaller molecular weight can also reach same capacity when it is used in the same weight as that of polypeptides with a larger molecular weight. It is believed that polypeptides with different molecular weights are equally effective in binding water and electrolytes under the same concentration (wt/dl) in the ISF. For example, 1 wt % of a polypeptide (1 gram per 100 ml) with a molecular weight 10 kDa is believed to be equally effective to 1 wt % of a polypeptide (1 gram per 100 ml) with a molecular weight 20 kDa in binding water and electrolytes. Thus, without wishing to be bound by theory, it is believed that different molecular weights do not substantially affect a polypeptide's capability of binding water and electrolytes, but do affect a polypeptide's capability of passing through endothelium of blood capillaries to enter into ISF. Further, without wishing to be bound by theory, it is believed that polypeptides having a molecular weight less than about 60 kDa and/or having a pI of higher than about 4.8 can readily pass through endothelium of blood capillaries to enter into ISF, thereby significantly increasing the polypeptide concentration in ISF and preventing or minimizing ischemia/reperfusion injury to a donor organ after the donor organ leaves the donor body. Preferably, the polypeptides described herein do not have a specific biological function (e.g., a function that allows polypeptides to enter into cell bodies, which reduces the polypeptide concentration in the ISF and accelerate ischemia/reperfusion injury to a donor organ).

To identify polypeptides that may be used in the compositions described above, standard cell culture techniques, such as primary neuron culture, liver cell culture, and muscle cell culture, can be used to compare their efficacy with that of albumin. The optimal polypeptides may be selected by their ability to enter the ISF by measuring the polypeptides in the lymphatic system of an animal. The optimal polypeptides are those effective in standard cell culture system and having a higher concentration in the lymph of the organ system.

Design and preparation of the polypeptides may employ, unless otherwise indicated, conventional techniques of cell biology, cell culture, molecular biology, transgenic biology, microbiology, recombinant DNA, and immunology, which are within the skill of the art. Such techniques are described in the literature. See, for example, Molecular Cloning A Laboratory Manual, 2nd Ed., ed. by Sambrook, Fritsch and Maniatis (Cold Spring Harbor Laboratory Press: 1989); DNA Cloning, Volumes I and II (D. N. Glover ed., 1985); Oligonucleotide Synthesis (M. J. Gait ed., 1984); Mullis et al. U.S. Pat. No. 4,683,195; Nucleic Acid Hybridization (B. D. Hames & S. J. Higgins eds. 1984); Transcription And Translation (B. D. Hames & S. J. Higgins eds. 1984); Culture Of Animal Cells (R. I. Freshney, Alan R. Liss, Inc., 1987); Immobilized Cells And Enzymes (IRL Press, 1986); B. Perbal, A Practical Guide To Molecular Cloning (1984); the treatise, Methods In Enzymology (Academic Press, Inc., N.Y.); Gene Transfer Vectors For Mammalian Cells (J. H. Miller and M. P. Calos eds., 1987, Cold Spring Harbor Laboratory); Methods In Enzymology, Vols. 154 and 155 (Wu et al. eds.), Immunochemical Methods In Cell And Molecular Biology (Mayer and Walker, eds., Academic Press, London, 1987); Handbook Of Experimental Immunology, Volumes I-IV (D. M. Weir and C. C. Blackwell, eds., 1986); and Manipulating the Mouse Embryo, (Cold Spring Harbor Laboratory Press, Cold Spring Harbor, N.Y., 1986), the contents of which are incorporated herein by reference in their entirety.

The polypeptides used in the compositions described above can have relatively low viscosity at least partly because they have smaller molecular weight.

The concentration of the polypeptides in the compositions described above can be in the range of about 1 g/dl to about 50 g/dl (such as about 1 g/dl to about 16 g/dl).

The data obtained from the cell culture assays can be used to screen effective polypeptides.

The organ preservation compositions described in this disclosure also include other nutrients, including about 0-155 meq/L (e.g., about 20-150 meq/L) of Na, about 0.1-5 meq/L (e.g., about 2-3 meq/L) of K, about 0.1-3 meq/L (e.g., about 1-2 meq/L) of Ca, about 0-150 meq/L (e.g., about 1-20 meq/L) of P, about 0-200 meq/L (e.g., about 20-150 meq/L) of Cl, about 1-200 meq/L (e.g., about 2-60 meq/L) of Mg, about 0-30 meq/L (e.g., about 10-20 meq/L) of HCO₃, about 0-150 meq/L (e.g., about 0-30 meq/L) of SO₄, about 0-200 mg/dl (e.g., about 20-120 mg/dl) of glucose, about 0-50 mM (e.g., about 5-50 mM) of a glycolysis stimulating reagent, water, about 0-200 mM (e.g., about 0.02-2 mM) of ATP, about 0-100 μU/ml (e.g., about 0-1 μU/ml) of insulin,

Magnesium (Mg²⁺) is the second highest electrolyte intracellularly (58 mEq/L). ATP (Adenosine 5′-triphosphate) is always present as a magnesium/ATP complex, in which Mg²⁺ provides stability to ATP. Further, it is believed that Mg²⁺ is required to activate more than 260 enzymes, including enzymes involved in phosphorylations and dephosphorylations, ATPases, phosphatases, and kinases for glycolytic pathway and krebs cycles. In addition, Mg²⁺ also affects the activities of pumps and channels regulating ion traffic across the cell membrane. The potential changes in tissue Mg²⁺ might affect the tissue ATP levels. Finally, in tissue culture and animal models, elevated Mg²⁺ concentration is believed to protect neurons and other cells. Thus, it is preferable to have a high Mg²⁺ in the organ preservation compositions described in this disclosure.

The concentration of ATP inside cells is high, whereas the concentration outside cells is very low. It is believed that exogenous ATP provides direct energy to the damaged tissue. Thus, it is also desirable to include ATP in a high concentration in the organ preservation compositions described in this disclosure.

In serum and ISF, Mg²⁺ concentration is only about 1.5-2.0 mEq/L, and ATP concentrations is only about 1 to 20 μmol/l. Although exogenous Mg²⁺ and ATP are conducive to ischemic tissue, infusion of high dose Mg²⁺ and ATP into human body results in blood pressure drop. However, this is no such issue when a donor organ is submerged in an organ preservation composition containing high concentration of Mg²⁺ and ATP since the donor organ has left the human body.

It is believed that insulin can yield protection for ischemic tissue (independent to its lowing blood glucose effect) and therefore it is desirable to include a high concentration of insulin in the organ preservation compositions described in this disclosure.

As a defense strategy, energy production of a donor organ switches from oxidative metabolism to anaerobic glycolysis after being harvested. Although glycolytic pathway does not provide energy as efficient as oxidative phosphorylation, it becomes crucial for the maintenance of the donor organ's viability after harvest. Reagents that can stimulate glycolysis is conducive to the viability of a donor organ, and therefore, can be added into a organ preservation fluid. Examples of such glycolysis stimulating reagents include glycolysis intermediates (such as fructose-1,6-biphophate, glyceraldehyde-3-phosphate, 1,3 bisphosphoglycerate, 3-phosphoglycerate, 2-phosphoglycerateare, phosphoenolpyruvate, pyruvate, or lactate), and enzymes for glycolysis (such as hexokinase, phosphoglucose isomerase, phosphofructokinase, aldolase, triosephosphate isomerase, glyceraldehydes 3-phosphate dehydrogenase, phosphoglycerate kinase, or pyruvate kinase). For example, fructose-2,6-biphosphate is a potent stimulator of key enzymes of glycolysis, and 0.01-50 mM of fructose-1,6 diphosphate can be added in addition to glucose or to replace glucose in the organ preservation composition.

This disclosure also features methods that include immersing at least a portion of a transplant (i.e., a donor organ) in one of the compositions described above. The methods can also include perfusing at least a portion of the transplant (e.g., through the artery of the transplant) with the composition prior to immersing the transplant in the composition. After the transplant is immersed in the composition, it can be stored at 4° C. for future use.

### EXEMPLIFICATION

The invention now being generally described, it will be more readily understood by reference to the following examples which are included merely for purposes of illustration of certain aspects and embodiments of the present invention, and are not intended to limit the invention in any way.

### Example 1

### Method of Identifying Useful Polypeptides

Neuron culture: Cortical neurons cultures were prepared from fetal Sprague-Dawley rats at 17-day gestation. Timed pregnant Sprague-Dawley rats were euthanized with isoflorane. After dissection of the cortical region of the fetal brain, cortical neurons were dispersed by trituration, centrifuged at 250 g for 5 minutes at 4° C., and suspended in a neurobasal medium supplemented with 25 μmol/L glutamic acid, 0.5 mmol/L glutamine, 1% antibiotic-antimycotic solution, and 2% B27 supplement. Cells were plated at 5×10⁵ cells/ml on poly-L-lysine-coated 24-well plates. Cytosine (10 μmol/) was added at day 3. Neuron cultures were fed every 4 days with replacement of half of neurobasal medium containing 0.5 mmol/L glutamine, 1% antibiotic-antimycotic solution, and 2% B27 supplement. The culture plates were incubated at 37° C. in a humid atmosphere with 5% CO₂.

In vitro neuron viability experiments were performed on cultures at 10-12 days. Specifically, cell culture media were replaced respectively by the following solutions:

A. Artificial cerebrospinal fluid (ACSF): Na⁺ 150 mEq/L, K⁺ 3.0 mEq/L, Mg²⁺ 0.8 mEq/L, Ca²⁺ 1.4 mEq/L, P 1.0 mEq/L, Cl⁻ 155 mEq/L, pH 7.0.

B. 2 wt % albumin (molecular weight 68 kDa, pI 4.8)+ACSF

C. 2 wt % polypeptides from trypsin digested albumin (molecular weight 5-30 kDa, pI 4.6-4.8)+ACSF

D. 2 wt % polypeptide from trypsin digested albumin which is further processed for increasing the pI by carbodiimide and ethylene diamine (molecular weight 5-30 kDa, pI 7)+ACSF

E. 2 wt % polypeptide from porcine skin gelatin digested by hydrochloride acid (molecular weight 1-10 kDa, pI 7-9)+ACSF

F. 2 wt % polypeptide from porcine skin gelatin digested by hydrochloride acid (molecular weight 50-100 kDa, pI 7-9)+ACSF

G. 2 wt % albumin with elevated pI by carbodiimide and ethylene diamine treatment (molecular weight 68 kDa, pI 7)+ACSF

Anoxic insult: After the above treatment, all cultures were subjected to an anaerobic environment of 95% N₂, 5% CO₂ for 60 minutes at 37° C. in a chamber. Anoxia was terminated by replacement of a normal culture medium and by returning the cultures to a standard incubator maintained at 37° C. in 5% CO₂.

Validation of neurons' survival: Neuronal viability was quantitatively evaluated by a methyl thiazole tetrazolium (MTT) reduction test. This quantifies the formation of a dark blue formazan product formed by the reduction of the tetrazolium ring of MTT by the mitochondrial succinate dehydrogenase in living cells. Specifically, twenty-four hours after anoxia, the cultures were incubated with MTT (250 μg/ml) at 37° C. in a culture medium for 3 hours. The cultures were then washed and incubated in 0.08 N HCl/isopropanol to dissolve the blue formazan product. Cell viability corresponded to the value of the optical density read at 570 nm with background subtraction at 630 nm. Results were expressed as percent of the optical density measured in normal control cells.

Results:

| | | Neuron's viability |
|---|---|---|
| Treatment | anoxia | (Percentage, Mean ± SD) |
| Culture medium | 0 mins | 100 ± 4.5 |
| A | 60 mins | 44 ± 5.5 |
| B | 60 mins | 96 ± 3.9 |
| C | 60 mins | 93 ± 5.8 |
| D | 60 mins | 94 ± 4.8 |
| E | 60 mins | 97 ± 5.8 |
| F. | 60 mins | 96 ± 6.8 |
| G | 60 mins | 96 ± 8.8 |

The results showed that when the neuronal cell culture medium was replaced by the ACSF and exposed to an anoxic environment, there was a low viability of neurons (A). The results also showed that supplementing ACSF with native bovine serum albumin significantly increased neuronal viability (B). Further, the results showed that supplementing ACSF with polypeptides of low molecular weight with various pI value exhibited much higher neuron's viability than supplementing ACSF with native bovine serum (C-E). Finally, the results showed that supplemental ACSF with polypeptides with a molecular weight large than or equal to 68 KDa and a pI value higher than 4.8 also exhibited higher neuron's viability than supplementing ACSF with native bovine serum (F-G).

### Example 2

Preparation of organ preservation fluid

| Component | Amount | |
|---|---|---|
| NaCl | 0.550 | gram |
| KCl | 0.224 | gram |
| CaCl₂•2H₂O | 0.206 | gram |
| Na₂HPO₄ | 0.113 | gram |
| NaH₂PO₄ | 0.023 | gram |
| MgCl₂ | 15.230 | gram |
| Glucose | 0.6 | gram |
| Gelatin Polypeptide (MW 1-10 kDa, pI 7-9) | 200 | gram |
| Insulin | 1,000 | μU |
| ATP disodium | 5.51 | gram |
| Sterile water for dilution to | 1000 | ml |

Final pH of the fluid was adjusted to a range between 7.31 with NaHCO₃

The final organ preservation fluid contains Na 30 mEq/L, K 3 mEq/L, Ca 1.4 mEq/L, Mg 160 mEq/L, Cl 190 mEq/L, P 1 mEq/L, ATP 10 mM, Glucose 60 mg/dl, insulin 1 μU/ml, Polypeptide 20%.

### Example 3

### Kidney Transplantation

Male CD rats (200 g) were used as donors and recipients. All recipients were bilaterally nephrectomized before engraftment. Donor kidneys were divided into two groups. In one group (n=5), the donor kidneys were perfused with 5 ml of normal saline from artery over 10 minutes, then stored in the saline at 4° C. for 24 hours. In the other group (n=5), the donor kidneys were perfused with 5 ml of the organ preservation fluid prepared according to Example 2 from artery over 10 minutes, then stored in the organ preservation fluid at 4° C. for 24 hours. Results showed that on day 7, the recipient survival rate was 10% in the group where the donor kidneys were stored in the saline. Unexpectedly, the recipient survival rate was 80% in the group where the donor kidneys were stored in the organ preservation fluid prepared according to Example 2.

### Example 4

Preparation of organ preservation fluid

| Component | Amount | |
|---|---|---|
| NaCl | 7.60 | gram |
| KCl | 0.224 | gram |
| CaCl₂•2H₂O | 0.206 | gram |
| Na₂HPO₄ | 0.113 | gram |
| NaH₂PO₄ | 0.023 | gram |
| MgSO₄ | 0.361 | gram |
| Glucose | 0.6 | gram |
| Albumin (MW68 kDa, pI 7) | 60 | gram |
| Sterile water for dilution to | 1000 | ml |

Final pH of the fluid was adjusted to a range between 7.31 with NaHCO₃

### Example 5

### Kidney Transplantation

Male CD rats (200 g) were used as donors and recipients. All recipients were bilaterally nephrectomized before engraftment. Donor kidneys were divided into two groups. In one group (n=5), the donor kidneys were perfused with 5 ml of normal saline from artery over 10 minutes, then stored in the saline at 4° C. for 24 hours. In the other group (n=9), the donor kidneys were perfused with 5 ml of the organ preservation fluid prepared according to Example 4 from artery over 10 minutes, then stored in the organ preservation fluid at 4° C. for 24 hours. Results showed that on day 7, the recipient survival rate was 10% in the group where the donor kidneys were stored in the saline. Unexpectedly, the recipient survival rate was about 78% in the group where the donor kidneys were stored in the organ preservation fluid prepared according to Example 4.

### EQUIVALENTS

Those skilled in the art will recognize, or be able to ascertain using no more than routine experimentation, many equivalents to the specific embodiments of the invention described herein. While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations. Such equivalents are intended to be encompassed by the following claims.

What is claimed is:

1. An article, comprising:
a composition comprising about 0-155 meq/L of Na, about 0.1-5 meq/L of K, about 0.1-3 meq/L of Ca, about 0-150 meq/L of P, about 0-200 meq/L of Cl, about 1-200 meq/L of Mg, about 0-30 meq/L of HCO₃, about 0-150 meq/L of SO₄, about 0-200 mg/dl of glucose, about 0-50 mM of a glycolysis stimulating reagent, water, about 0-200 mM of ATP, about 0-100 μU/ml of insulin, and an effective amount of a polypeptide having a molecular weight of less than about 60 kDa; and
a transplant, at least a portion of which being in the composition.

2. The article of claim 1, wherein the polypeptide has a molecular weight of less than about 45 kDa.

3. The article of claim 1, wherein the polypeptide has a molecular weight of less than about 30 kDa.

4. The article of claim 1, wherein the polypeptide is an albumin derivative.

5. The article of claim 1, wherein polypeptide is gelatin, sericin, or a derivative thereof.

6. The article of claim 1, wherein the polypeptide is a chemically synthesized polypeptide.

7. The article of claim 1, wherein the polypeptide is a recombinantly produced polypeptide.

8. The article of claim 1, wherein the polypeptide has an isoelectric point of more than about 4.8.

9. The article of claim 1, wherein the composition comprises about 20-150 meq/L of Na, about 2-3 meq/L of K, about 1-2 meq/L of Ca, about 1-20 meq/L of P, about 20-150 meq/L of Cl, about 2-60 meq/L of Mg, about 10-20 meq/L of HCO₃, about 0-30 meq/L of SO₄, about 20-120 mg/dl of glucose, about 0-50 mM of a glycolysis stimulating reagent, water, about 0.02-2 mM of ATP, about 0-1 μU/ml of insulin

10. The article of claim 1, wherein the transplant is a heart transplant, a kidney transplant, a liver transplant, a lung transplant, a brain transplant, a spinal cord transplant, or an intestine transplant, skin transplant.

11. An article, comprising:
a composition comprising about 0-155 meq/L of Na, about 0.1-5 meq/L of K, about 0.1-3 meq/L of Ca, about 0-150 meq/L of P, about 0-200 meq/L of Cl, about 1-200 meq/L of Mg, about 0-30 meq/L of HCO₃, about 0-150 meq/L of SO₄, about 0-200 mg/dl of glucose, about 0-50 mM of a glycolysis stimulating reagent, water, about 0-200 mM of ATP, about 0-100 μU/ml of insulin, and an effective amount of a polypeptide having an isoelectric point of more than about 4.8; and
a transplant, at least a portion of which being in the composition.

12. The article of claim 11, wherein the polypeptide has an isoelectric point of more than about 6.

13. The article of claim 11, wherein the polypeptide has an isoelectric point of more than about 7.

14. The article of claim 11, wherein the polypeptide is an albumin derivative.

15. The article of claim 11, wherein the polypeptide is gelatin, sericin, or a derivative thereof.

16. The article of claim 11, wherein the polypeptide is a chemically synthesized polypeptide.

17. The article of claim 11, wherein the polypeptide is a recombinantly produced polypeptide.

18. The article of claim 11, wherein the composition comprises about 20-150 meq/L of Na, about 2-3 meq/L of K, about 1-2 meq/L of Ca, about 1-20 meq/L of P, about 20-150 meq/L of Cl, about 2-60 meq/L of Mg, about 10-20 meq/L of HCO₃, about 0-30 meq/L of SO₄, about 20-120 mg/dl of glucose, about 0-50 mM of a glycolysis stimulating reagent, water, about 0.02-2 mM of ATP, about 0-1 μU/ml of insulin.

19. The article of claim 11, wherein the transplant is a heart transplant, a kidney transplant, a liver transplant, a lung transplant, a brain transplant, a spinal cord transplant, or an intestine transplant, skin transplant.

20. A method, comprising immersing at least a portion of a transplant in a composition comprising 0-155 meq/L of Na, 0.1-5 meq/L of K, 0.1-3 meq/L of Ca, 0-150 meq/L of P, 0-200 meq/L of Cl, 1-200 meq/L of Mg, 0-30 meq/L of HCO₃, 0-150 meq/L of SO₄, 0-200 mg/dl of glucose, about 0-50 mM of a glycolysis stimulating reagent, water, 0-200 mM of ATP, 0-100 μU/ml and insulin, and an effective amount of a polypeptide having a molecular weight of less than about 60 kDa.

21. The method of claim 20, further comprising perfusing at least a portion of the transplant with the composition prior to immersing the transplant in the composition.

22. The method of claim 20, wherein the polypeptide has an isoelectric point of more than about 4.8.

23. A method, comprising immersing at least a portion of a transplant in a composition comprising 0-155 meq/L of Na, 0.1-5 meq/L of K, 0.1-3 meq/L of Ca, 0-150 meq/L of P, 0-200 meq/L of Cl, 1-200 meq/L of Mg, 0-30 meq/L of HCO₃, 0-150 meq/L of SO₄, 0-200 mg/dl of glucose, about 0-50 mM of a glycolysis stimulating reagent, water, 0-200 mM of ATP, 0-100 μU/ml and insulin, and an effective amount of a polypeptide having an isoelectric point of more than about 4.8.

24. The method of claim 23, further comprising perfusing at least a portion of the transplant with the composition prior to immersing the transplant in the composition.
